(19) United States
(12) Patent Application Publication
(10) Pub. No.: US 2001/0027075 A1
(43) Pub. Date: Oct. 4, 2001

(54) Form-stable filter element

(75) Inventors: Georg Leppla, Backnang (DE); Helmut Hiltwein, Markqroningen (DE); Holger Lochmann, Frankfurt (DE); Igor Klaric, Korb (DE); Maximilian Eberhardt, Esslingen (DE)

Correspondence Address: Walter Ottesen, Patent Attorney, P.O. Box 4026, Gaithersburg, MD, 20885-4026, US

(73) Assignee: Andreas Stihl AG & Co.

(21) Appl. No.: 09/820,626

(22) Filed: Mar. 30, 2001

(30) Foreign Application Priority Data
Apr. 1, 2000 (DE) 200 06 072.4

(51) Int. Cl. B32B 5/18; D04H 1/08; B32B 5/24

(52) U.S. Cl. 442/370; 442/320

(57) ABSTRACT

The invention relates to a filter element of at least two filter layers (10, 20) wherein the one filter layer (20) is formed from a non-woven fabric (21) and the other filter layer (10) is of an open-pore foam (11) which is attached to the one filter layer (20). Furthermore, a carrier is provided which supports the filter element (1). In order to properly mount the filter element in the filter housing, the non-woven fabric is a felt (21) stiffened by impregnation with a curing liquid. The felt (21) imparts rigidity as a carrier to the filter element (1).

### FIELD OF THE INVENTION

The invention relates to a filter element having at least two filter layers of which one filter layer is made of non-woven fiber fabric and the other filter layer is made of an open-pore foam attached to the one filter layer. The filter element also includes a carrier supporting the filter element.

### BACKGROUND OF THE INVENTION

A filter element of this kind is disclosed in German patent publication 3,614,949. To stiffen the needle felt, an inner-lying flexible support fabric is provided which is intended to impart an adequate strength to the felt. On the one flat side, an open-pore plastic foam is intercalated completely in the needle felt with the filter element itself remaining flexible. This flexibility of the filter element ensures a good adaptation to the spatial configuration of a filter housing but the user must be sure that the filter element is properly seated during assembly. Even small leakages lead to ineffectiveness of the filter element which, in turn, leads to a considerable loading of the combustion air inducted by the engine with dirt particles. These dirt particles can lead to damage to the engine.

In practice, a dirtied filter element is washed and reused many times until it is replaced by a new filter element. The flexible configuration of the filter element permits a simple washing but wringing the filter element leads to a change in form which can lead to leakage locations in a subsequent assembly of the filter element in the filter housing.

### SUMMARY OF THE INVENTION

It is an object of the invention to improve a filter element of the kind described above so that the filter element can be properly mounted in the filter housing even by an inexperienced user.

The filter element of the invention includes: a first filter layer formed of a non-woven fabric; a second filter layer formed of an open-pore foam attached to the first filter layer; and, the non-woven fabric being a felt strengthened by an impregnation of a curing liquid to cause the first filter layer to function as a carrier imparting stiffness to the filter element.

The felt is impregnated with a curing liquid and surprisingly retains its filter characteristics substantially unchanged and, at the same time, forms a rigid body which is essentially stable with respect to form. This rigid body can only be deliberately deformed by the user. The impregnation leads to a bonding of the individual fibers of the felt with each other from which the increased stiffness and form stability of the filter results and this without significantly affecting the filter characteristics. An easy precise fit when placing the filter element in the corresponding filter receptacle of the filter housing is ensured by the stiffness of the filter element. The sequence of prefilter (foam) and main filter (felt) is pregiven because of the one-piece configuration given constructively by the tight bond. Leakage locations can be avoided with high reliability during assembly so that damage to the engine, which is connected to the air filter, because of inducted dirt particles is substantially precluded.

The curing liquid can be cured by chemical reaction of corresponding components or with the application of heat. Preferably, the liquid is a resin such as a phenol resin which has shown to be advantageous in practical experiments.

The open-pore foam is attached to the cured felt by adhesive or welding. A powder adhesive or a two-component adhesive can be used as an adhesive application. The application of the adhesive, preferably in the form of a uniform lattice, can take place so that the air passes through the sandwich-like assembled filter element without being significantly hindered. Alternatively, the foam layer can be thermally welded to the felt layer over the surface thereof or can be needled. Likewise, the bond can be achieved by flame lamination.

In order to achieve a good filter action, a thin fine-fiber felt layer is mounted at the clean air side as a last filter layer. This felt layer forms a blocking layer for fine dust and additionally ensures an excellent sealing of the filter element at the edge of the filter housing.

### BRIEF DESCRIPTION OF THE DRAWINGS

The invention will now be described with reference to the drawings wherein:

FIG. 1 is a section view of a filter element according to the invention; and,

FIG. 2 is a perspective view of the filter element according to the invention.

### DESCRIPTION OF THE PREFERRED EMBODIMENTS OF THE INVENTION

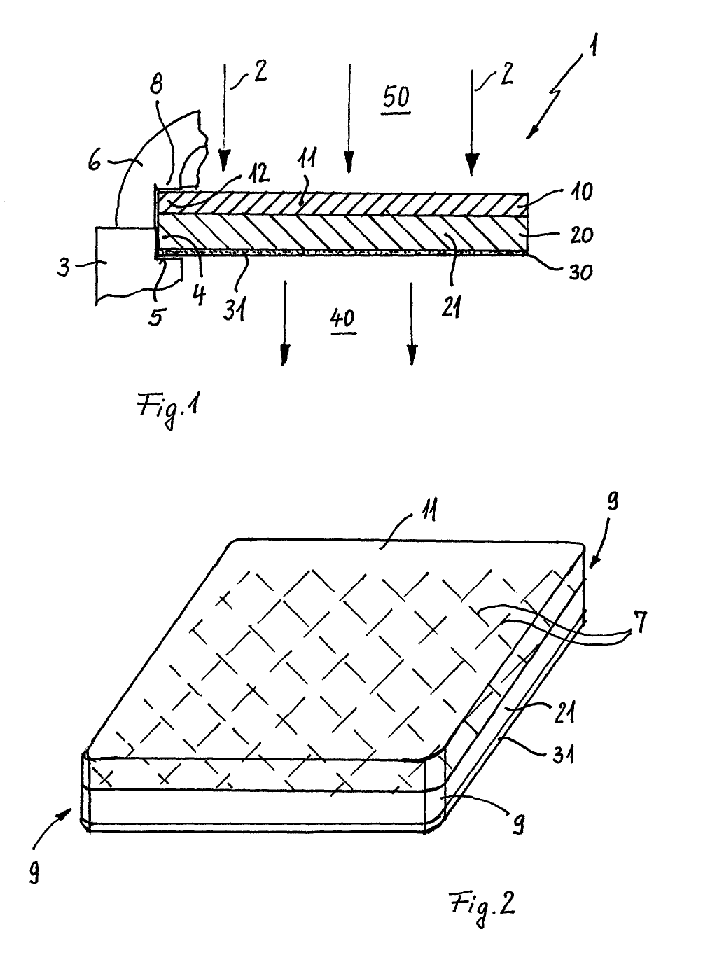

The filter element 1 shown in FIGS. 1 and 2 is provided for use in an intake air filter of an internal combustion engine. The filter element 1 is disposed transversely to the flow path of the inducted combustion air 2 and the combustion air flows as indicated by the arrows in FIG. 1. As shown schematically in FIG. 1, the filter element 1 is placed with its edge 4 into a receptacle 5 of a filter housing lower portion 3. The filter element 1 is fixed in the receptacle 5 essentially air tight with a cover 6 which likewise engages at the periphery 4 of the filter element.

The filter element shown comprises a first filter layer 10, a second filter layer 20 and, preferably, a third filter layer 30. The second center filter layer 20 is formed from a non-woven fabric in the form of a felt 21. The felt 21 is essentially completely covered by an open-pore foam 11 on the flat side facing toward the incoming combustion air 2. The foam 11 defines the first filter layer 10. A thin fine-fiber felt layer 31 is arranged on the side of the felt 21 facing away from the foam 11. This fine-fiber felt layer 31 functions as a fine filter. The felt layer 31 lies on the downstream end of the filter element 1 facing away from the foam layer 11.

The open-pore foam 11 is attached to the felt 21 of the second filter layer 20 so as to congruently cover the same. This attachment is preferably with adhesive and, as shown in FIG. 2, the application of adhesive is in the form of a preferably uniform lattice 7. The lattice 7 ensures that the inflowing combustion air 2 can flow through the adhesive application essentially without disturbance. An application via spraying is also advantageous especially with a powdered adhesive.

According to the invention, the felt 21 of the center filter layer 20 is stiffened by impregnation with curing liquid. The stiffening takes places in such a manner that the felt 21 forms a rigid body which is essentially stable with respect to form and imparts rigidity to the filter element 1 as carrier. In this way, it is ensured that the filter element 1 can be placed with a precise fit into the receptacle 5 of the filter housing so that even a user with little experience can achieve a proper assembly of the filter element in the filter housing. The foam 11 is configured in color to identify the inflow end of the filter element 1. The foam 11 is tightly bonded to the cured felt 21 of the filter layer 20 so that it cannot be displaced. For this reason, the edge of the felt 21 will lie at a correct position to the cover 6 so that, when the cover 6 is closed, the edge 8 of the cover lies seal-tight against the periphery 12 of the foam 11. The clean air side 40 of the filter housing is separated from the dirt contaminated side 50 in an air-tight manner.

It is practical to align the felt 21 with respect to its form before curing of the felt 21 of the center filter layer 20 because of the curing liquid. The curing of the liquid can take place via a chemical reaction of components mixed together or can be initiated via a heat treatment. Preferably, the liquid is a resin and especially a phenol resin.

The rigid felt 21 is essentially form stable and permanently determines the shape of the filter element. The form stability is not affected even under the influence of moisture. The curing liquid which imparts the stiffness is preferably waterproof.

A simple placement of the essentially rectangular filter element 1 (which is especially quadratic) is facilitated by rounding the corners 9 which are perpendicular to the filter layers 10, 20 and 30. Any other form adapted to the filter housing can be provided as a deviation from the four-cornered form shown of the filter element 1 which has the form of a cracker. The form stable shape permanently ensures a non-changeable form because of the felt impregnated with curing liquid which provides a leak-free assembly even after repeated use in the filter housing.

The filter layers 10, 20 and 30 are configured with respect to their thicknesses so that the first filter layer of open-pore foam corresponds approximately to the thickness of the felt 21 of the second filter layer 20. The felt 21 is stiffened with the cured liquid. The fine filter layer 30 has a thickness which corresponds approximately to one third to one fifth of the thickness of the center form stable filter layer 20. It is practical to stiffen the fine filter layer 30 by impregnation with a curing liquid and especially to configure the same as one piece with the center filter layer 20. The filter element is made up of several filter layers and forms a one-piece component.

It can be advantageous to thermally weld the foam layer to the cured felt 21 over the surface areas thereof.

It is understood that the foregoing description is that of the preferred embodiments of the invention and that various changes and modifications may be made thereto without departing from the spirit and scope of the invention as defined in the appended claims.

What is claimed is:

1. A filter element comprising:
a first filter layer formed of a non-woven fabric;
a second filter layer formed of an open-pore foam attached to said first filter layer; and,
said non-woven fabric being a felt strengthened by an impregnation of a curing liquid to cause said first filter layer to function as a carrier imparting stiffness to said filter element.

2. The filter element of claim 1, wherein said felt defines a form stable body which is essentially rigid.

3. The filter element of claim 1, wherein said liquid is a chemically curing liquid.

4. The filter element of claim 1, wherein said liquid is a thermally curing liquid.

5. The filter element of claim 1, wherein said liquid is a chemically and thermally curing liquid.

6. The filter element of claim 1, wherein said liquid is a resin.

7. The filter element of claim 6, wherein said resin is a phenol resin.

8. The filter element of claim 1, wherein said open-pore foam is attached to the cured felt with adhesive.

9. The filter element of claim 8, wherein said adhesive is a two-component adhesive.

10. The filter element of claim 8, wherein said adhesive is in the form of a powder application.

11. The filter element of claim 8, wherein the adhesive application is in the form of a lattice.

12. The filter element of claim 11, wherein said lattice is a uniform lattice.

13. The filter element of claim 1, wherein the form-stable felt has a side facing away from said open-pore foam; and, wherein said filter element further comprises a fine-filter layer arranged on said side; and, said fine-filter layer is in the form of a thin fine fiber felt layer.

14. The filter element of claim 1, wherein said filter element is washable.

15. The filter element of claim 1, wherein filter element has corners perpendicular to said filter layers thereof; and, said corners are rounded in the peripheral direction of said filter element.

16. The filter element of claim 1, wherein said open-pore foam is thermally welded to said felt.
